(19) United States
(12) Patent Application Publication
(10) Pub. No.: US 2016/0320081 A1
(43) Pub. Date: Nov. 3, 2016

(54) Method and System for Personalization of Heating, Ventilation, and Air Conditioning Services

(71) Applicant: Mitsubishi Electric Research Laboratories, Inc., Cambridge, MA (US)

(72) Inventor: Daniel Nikolaev Nikovski, Brookline, MA (US)

(21) Appl. No.: 14/697,943

(22) Filed: Apr. 28, 2015

(51) Int. Cl. F24F 11/00; G05B 13/04; G06N 99/00; G06F 17/30

(52) U.S. Cl. CPC F24F 11/006; G06F 17/30604; G06F 17/30321; G05B 13/048; G06N 99/005

(57) ABSTRACT

A method and system personalizes a heating ventilation and air conditioning (HVAC) system for an occupant in an environment, by first obtaining biometric data of the occupant and measuring continuously environmental data in the environment as current conditions. An estimate of a comfort index of the occupant is adapted continuously based on the current conditions. Then, the HVAC system is controlled based on the estimate of the comfort index to personalize the HVAC system.

### FIELD OF THE INVENTION

The invention pertains generally to heating, ventilation, and air conditioning (HVAC) systems, and more particularly to automatic customization of adjustable settings such as temperature set-points and amount of latent heat transferred by the system, in order to maximize a comfort and minimize energy consumption.

### BACKGROUND OF THE INVENTION

HVAC systems in environments, such as office and residential buildings, are among the largest consumers of energy in the world, spending in excess of 40% of all energy, by some estimates. This is due to the large importance attached to indoor climate conditioning in modern society, and its impact on people's productivity and well-being. However, the continuous maintenance of thermal comfort is currently implemented in a suboptimal and inefficient manner, primarily because of the predominant very rudimentary way of communication between building occupants and HVAC systems.

For the most part, such communication takes place by means of either a wall thermostat or a remote control device, whose purpose is mainly to turn the equipment on or off, and set temperature set-points. The on/off switch indicates when service is needed and when it is not (and thus energy can be saved by turning the equipment off). The temperature setting is a way of indicating a desired level of thermal comfort, in accordance with the needs and thermal condition of building occupants. For example, when an office worker has been sitting still at a desk for a long period of time on a cold winter day, the worker is likely to feel cold due to a lower metabolic rate, and request more heating by increasing the temperature set-point. Similarly, when a manual laborer has been performing vigorous physical work on a hot and humid summer day, the worker is likely to feel very hot, and can request more cooling by lowering the temperature set-point.

In principle, these two controls (on/off switch and temperature set-points) should be sufficient to always provide optimal thermal comfort and/or save energy, when possible. In practice, this almost never happens, due to a number of reasons. The main reason is that constant manual readjustment of temperature set-points is not practical, and would present a major distraction for most building occupants. In real life, such readjustment happens only when indoor climate becomes drastically uncomfortable.

A second, related reason is that even when an occupant is willing to adjust the temperature set-point, the occupant rarely knows what the optimal value is. As mentioned above, that value depends a lot on the current level of physical activity, respectively metabolic rate, the humidity of air, the clothing worn by the occupant, as well as the amount of radiant heat radiated by other objects in the room, as well as external heat sources such as the sun.

Models for predicting thermal comfort based on most of these factors do exist, such as ISO 7730, and ASHRAE 55, but very few people would be able to apply those models in a real situation to determine the optimal temperature correctly. In most cases, only the sign of the needed correction can be determined, e.g., temperature up or down, with further corrections being necessary later, at the cost of more wasted time and distraction. Over-correction is also a frequently observed phenomenon, for example when an occupant that feels cold chooses unnecessarily high temperature set-point, in the hope that he would get warms faster; most often, the only thing such an instruction would achieve is bring the room temperature to another uncomfortable state, making the occupant feel too hot.

A third reason for suboptimal regulation of thermal comfort is that the temperature sensors of most HVAC systems are located at the HVAC device itself, and measure the temperature of return air just before it enters the device. However, building occupants are typically not interested in the air temperature at that location; rather, the occupants want comfortable temperature at their own locations. Because those locations might be quite far from the HVAC device, and also significant temperature gradients exist in most building zones, the air temperature sensed and regulated by the HVAC device might be very different from that experienced by the zone occupant.

Vass et al. (Room thermal comfort monitor, U.S. Pat. No. 8,700,227) describe a monitoring device that attempts to determine the actual comfort level in a room from sensor measurements, but those measurements are specific to the room, and not to a particular occupant and his/her condition and/or location. Similarly, Bu et al, (Thermal comfort sensing device, U.S. Pat. No. 5,374,123) describe a sensing device that models the way the human body accumulates and senses heat, but it has the same disadvantage of not matching the specific condition and a location of a particular person. In a further extension of the idea (Bu et al., Method for calculating PMV of air conditioning system, U.S. Pat. No. 5,674,007), a body sensor measures personal thermal condition, but still default (and possibly very imprecise) values for clothing and activity levels according to the season and the time of the day were used in order to employ the ISO 7330 standard for predicting comfort level.

Other methods for estimating thermal comfort, such as the one described by Van Treeck et al., Method and device for detecting thermal comfort, U.S. 20140148706, might provide personalized estimates of thermal comfort, but rely on expensive infrared imaging devices that can be expected to have limited adoption.

In addition, in environments where multiple occupants share the same climate, because they occupy the same zone, it is not customary to allow any one of the occupants to turn the equipment off, because that might result in significant discomfort for other occupants. As a result, very often completely empty zones, such as conference rooms and laboratories, are air conditioned without any good reason and at a significant expense. Even when the zone is occupied, the optimal temperature set-point that would satisfy the current set of occupants in the best possible way is difficult to determine; in most cases, the result is either “thermostat wars,” or hopeless resignation to poor thermal comfort.

What is needed, then, is an automated method for controlling HVAC equipment that maximizes thermal comfort for one or more zone occupants, each of whom has their own preferences, without the need for excessive distracting manual interaction with the HVAC device, and also fully exploiting possibilities for energy saving, when they arise.

### SUMMARY OF THE INVENTION

The embodiment of the invention provides a method and system for learning a predictive model for a comfort index from biometric data using wearable devices, and using the model to optimize the comfort index directly.

The method learns individual preferences about thermal comfort of building occupants appropriate for a particular state associated with the occupant, and current environmental conditions.

The method uses historical feedback data provided by occupants by means of wearable devices, as well as biometric data, such as temperature, heart rate, activity level, calories burned, galvanic skin response, etc., also collected by the wearable devices.

The method estimates a probability that a particular temperature set-point would be comfortable for occupants, given measured values of biometric data and environmental conditions. A number of classification learning procedures can be used to learn the model, such as logistic regression, decision trees, multilayer perceptrons, support vector machines, etc. An initial model can be obtained from default values of measured biometric variables, based on existing standards for thermal comfort.

### BRIEF DESCRIPTION OF THE DRAWINGS

FIG. 1 is a schematic of a method and system for learning a predictive model for a comfort index from biometric data using wearable devices, and using the model to optimize comfort directly; and

FIG. 2 is a wearable device for registering feedback from occupants about their current thermal comfort.

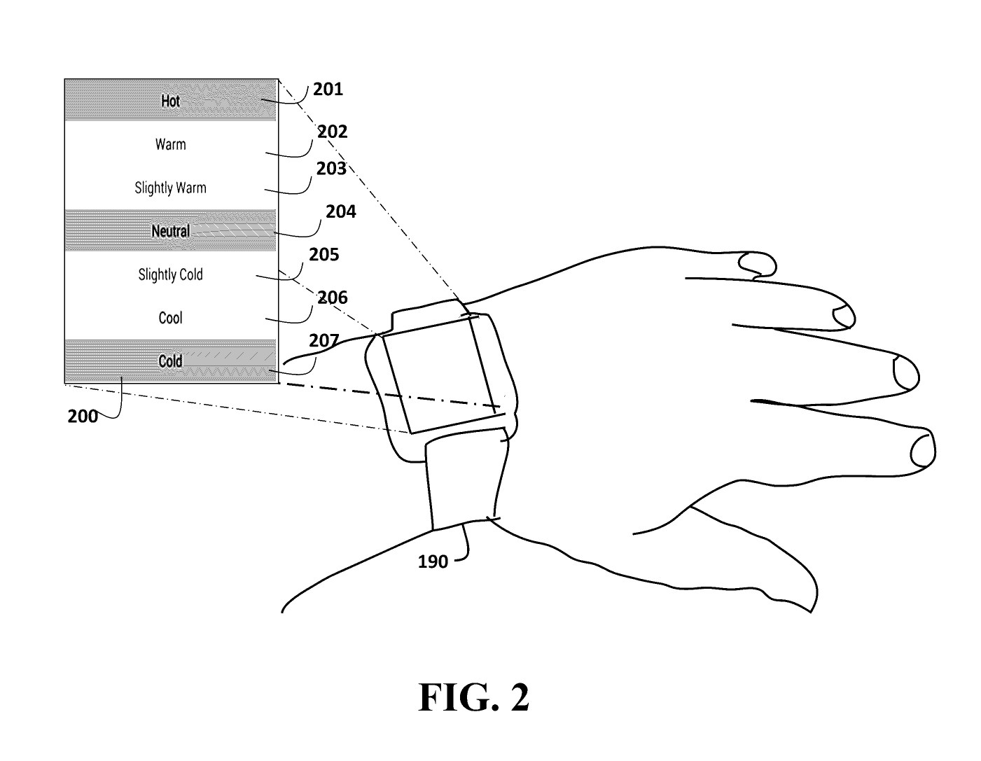

### DETAILED DESCRIPTION OF THE PREFERRED EMBODIMENTS

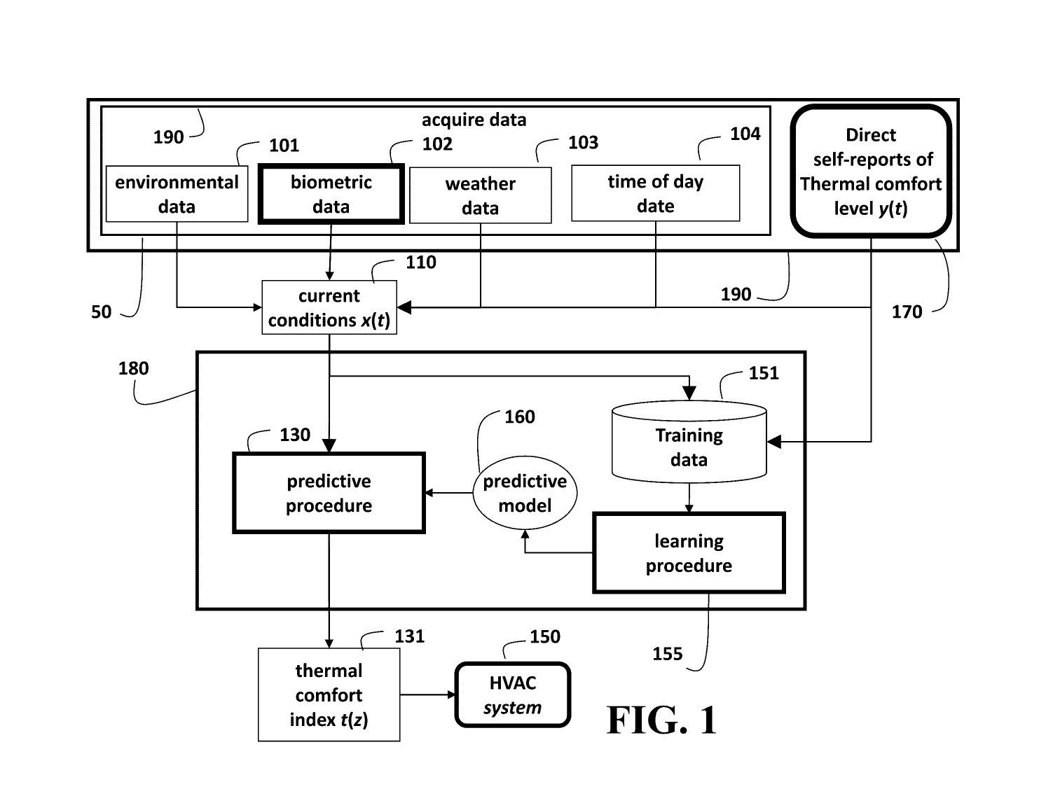

As shown in FIG. 1, the embodiment of the invention provide a method and system for learning a predictive model for a comfort index from biometric data using wearable devices, and using the model to optimize occupant comfort directly. The invention addresses the problem of determining what controllable settings of a HVAC 150 system, such as temperature set-points, would result in maximal comfort for an occupant, given a current state associated with the occupant.

The input data for the method are acquired measurements 50 that include environmental data 101, such as the indoor room temperature and humidity, biometric data 102, weather data 103, time of day and date 104, and data, such as reported comfort level 170, obtained from a wearable device 190.

The invention is based on the idea that the comfort level of the occupant, although not completely measurable, can be inferred from various biometric measurements 102 conveniently acquired by means of the wearable device 190, such as a smart watch or a fitness band, in combination with data about the indoor temperature and humidity 101, and possibly also weather data 103 about cloud cover and solar radiation on that day at that location.

The wearable device can measure variables, such as skin temperature, heart rate, general activity level, and galvanic skin response that are strongly correlated with physical variables relevant to thermal comfort, such as body temperature and rate of perspiration, which means that the variables can be expected to influence directly the decision whether a specific target air temperature, as specified by the temperature set-point of an HVAC system thermostat, would be comfortable.

However, the actual relationship between these variables and thermal comfort is very difficult to quantify. Moreover, this relationship might vary as a result of additional environmental variables, such as air speed, radiant heat, and the occupant's clothing These additional variables are typically difficult to measure, and act as confounding factors in the calculation of comfort; that is, their values might alter and/or offset the relative effect of the measurable variables. As a result, it is not practical to apply the approach typical for standards for thermal comfort such as ISO 7730 and ASHRAE 55, where concrete numerical values are listed for the strength of impact of each factor. Other, even more detailed physical models, such as Baker et al., “Thermal comfort model having multiple fabric layers,” U.S. Pat. No. 8,005,655, are even less practical for repeated evaluation of thermal comfort, because those models require full knowledge of a physical environment that can only be obtained in laboratory conditions.

The solution to this problem is to continuously learn and update a predictive model 160 for a comfort index 131 that relates a vector of measurable variables x(t) of the current conditions 110 (input data) at a time t to a variable y(t) 170 indicating how comfortable the occupant is at that time, given settings (output data) for a vector of unmeasurable variables z(t) that are assumed to be relatively constant over the learning and prediction period. The updates model can ignores past data older than a prespecified time in the past.

Effectively, the method learns the highly customized predictive model 160 that predicts whether an occupant is comfortable given measurements of the indoor temperature and humidity 101 in the environment, and also the biometric data 102, such as skin temperature, heart rate, activity level, galvanic skin response, etc., for fixed specific values of the air flow and radiant heat in the thermal zone at a specific time, and the specific clothes worn by the occupant on that day.

Unlike a thermal comfort evaluation expression in one of the thermal standards, which remains always the same, the predictive model according to the embodiments is adaptive over time, and is constantly re-learned and adapted from the acquired collected biometric 102 and environmental data 101 and 103, for example, from current and previous times.

Because the form of the predictive model 160 is of the kind known in the field of machine learning as a regression model, any number of machine learning procedures can be used to learn that model from the acquired data, provided that the data are organized in a suitable format.

Machine learning procedures can discover a hidden relationship between vectors of input data variables x and output data variables y, on the basis of past data 151 collected and organized into a training set of M examples, where each example is a pair (x^{(k)}, y^{(k)}), k=1 to M. The input vector x=[x₁, x₂, . . . , x_{N}] has N components that can either be direct biometric measurements 102 (for example, skin temperature or heart rate) from the wearable device or environmental conditions 101 and 103, or can be derived from them by means of mathematical expressions or extraction procedures, for example, estimates of overall activity levels or calories burned computed from accelerometer sensors that measure motion and activity. Some components of the input vector xᵢ can be time averages of biometric measurements are used as input features of the predictive model, such as the average heart rate over the last 10 minutes, or derived expressions that involve this data.

The output variable y 170 indicates the comfort level of the occupant at a given moment. After the training data set 151 is prepared in this format, a number of machine learning procedures 155, such as linear regression, support vector regression, polynomial regression, radial basis function regression, etc. can be used to learn the predictive model from data, and use it for predictions for thermal comfort in the future, e.g., Hall et al., “The WEKA Data Mining Software: An Update; SIGKDD Explorations,” Volume 11, Issue 1, 2009. Models of this kind that depend only on the air temperature, and are not personalized by personal biometric data, and predict only a Boolean indicator of comfort, have been learned from data in the past, see e.g., Tanimoto et al., “State transition probability for the Markov Model dealing with on/off cooling schedule in dwellings.” Energy and Buildings 37.3, 181-187, 2005.

However, whereas biometric data can be collected conveniently by means of wearable devices such as smart watches and fitness bands, immediate indication of whether particular indoor climate is comfortable for a specific occupant or not, is not readily available.

The method according to the embodiments collect positive and negative feedback about occupant comfort by means of a dedicated application (app) on the wearable device 190, where choices 200 are provided to indicate comfort levels. The choices can include hot 201, warm 202, neutral 203 slightly cold 204, cool 205, and cold 206. The occupant can indicate the comfort level on the wearable device, using, e.g., a touch sensitive screen, to self-report the choice of the selected comfort level.

In accordance with thermal standards, numerical values between −3 and +3 can be assigned to these choices, such that hot 201 is +3, cold 206 is +3, and neutral 203 is 0. The occupant of a thermal zone wearing such a wearable device can then provide such information quite conveniently. When an uncomfortable thermal condition is encountered, this is also a convenient way for the occupant to signal such discomfort to the HVAC system. The current invention will then take the necessary measures to improve thermal comfort by adjusting the temperature set-point, relieving the occupant from the need to do that.

In practice, it is likely that occupants would provide negative feedback much more often than positive one, because the occupants pay attention to the indoor climate mostly when it is uncomfortable, and ignore it otherwise. So, in general, this feedback is—the absence of negative feedback can be considered positive.

One other complicating factor is that it is much more convenient for occupants to provide feedback only relatively infrequently, when thermal conditions have just become uncomfortable. However, due to the persistence of thermal conditions over relatively long periods, when negative feedback is given, it can be inferred that the conditions immediately before and after the moment feedback was given were uncomfortable, too. For this reason, labels y^{(k)} indicating discomfort are produced not only for the moment k when the occupant explicitly indicated discomfort, but also for a window of time of specified duration before and after that moment.

An alternative method to train a thermal comfort classifier is to use eligibility traces, commonly employed in the field of reinforcement learning in situations when the cause of a particular outcome might have happened in the past. Thermal comfort has similar characteristics—an indication of thermal discomfort might result not only from the environmental conditions at the current moment, but also from these conditions in the immediate past. The reason for this is that thermal discomfort typically results from a heat imbalance over a period of time, when excess heat accumulates and provides the sensation of overheating, or a shortage of heat accumulates until a person starts feeling cold.

After the predictive model 160 is learned, it is used at regular intervals, for example every minute, to optimize the temperature set-point of the HVAC system 150 using a search procedure 130 that employs the predictive model 160. In many HVAC systems, this also implicitly sets the rate of moisture removal from the air. in the environment. To this end, a one dimensional search over the indoor temperature set-point is performed by inputting its values into the predictive model, while all other inputs are set according to the biometric measurements currently collected from the occupant. The value of the temperature set-point that maximizes thermal comfort according to the predictive model is then selected. In another embodiment of the invention, the most economic temperature set-point that would result in thermal comfort that exceeds a prespecified threshold, or is within prespecified comfort interval) is selected.

The method can be performed in a processor 180 connected to memory and input/output interfaces by busses as known in the art. The processor can communicated with the wearable device using a wireless communication network.

The temperature set-point that results in the maximum comfort is then selected and communicated to the HVAC system, whose controller then targets it for regulation. If multiple occupants who use an embodiment of the invention are present, then each one of their individual predictive models is evaluated in turn, and a temperature set-point optimal for all of them is selected, for example by maximizing a sum of their predicted thermal comfort, or maximizing the lowest among their respective probabilities of feeling comfortable.

Alternatively, in energy economizing mode, a temperature set-point can be selected that is the most economical, e.g., the highest in cooling mode and the lowest in heating mode, such that the probability for feeling comfortable exceeds a given threshold for all occupants of the thermal zone.

Although the invention has been described by way of examples of preferred embodiments, it is to be understood that various other adaptations and modifications may be made within the spirit and scope of the invention.

Therefore, it is the object of the appended claims to cover all such variations and modifications as come within the true spirit and scope of the invention.

I claim:

1. A method for personalizing a heating ventilation and air conditioning (HVAC) system for an occupant in an environment, comprising steps;
obtaining biometric data of the occupant and measuring continuously environmental data in the environment as current conditions;
adapting continuously an estimate of a comfort index of the occupant based on the current conditions; and
controlling the HVAC system based on the estimate of the comfort index to personalize the HVAC system, wherein the steps are performed in a processor.

2. The method of claim 1, where the adapting is performed on a predictive model, and the model is used to directly optimize the comfort level of the occupant in the environment, further comprising:
acquiring weather data, indoor temperature and humidity data, time of day and date, and the biometric data as the current conditions, and a self-reported comfort level of the occupant using a wearable device;
storing the current conditions and comfort level in a data base as training data; and
learning the predictive model from the training data; and
determining the comfort index according to the predictive model.

3. The method of claim 1, wherein the controlling further comprises:
adjusting temperature set-points of the HVAC system.

4. The method of claim 1, wherein the biometric data includes skin temperature, heart rate, activity level, and galvanic skin response, body temperature, and rate of perspiration of the occupant.

5. The method of claim 2, further comprising:
updating the model over time.

6. The method of claim 2, wherein the learning comprises:
learning a hidden relationship between the current conditions and the comfort level.

7. The method of claim 2, wherein the learning uses linear regression, support vector regression, polynomial regression, or radial basis function regression.

8. The method of claim 1, further comprising:
collecting positive and negative feedback about the comfort level from the occupant.

9. The method of claim 2, wherein the learning uses eligibility traces.

10. The method of claim 1, wherein the current conditions data are collected about every minute.

11. The method of claim 1, wherein the environment includes multiple occupants, and the current comfort level maximizing a lowest comfort level for all of the occupants.

12. The method of claim 1, wherein the controlling optimizes energy consumption.

13. A system for personalizing a heating ventilation and air conditioning (HVAC) system for an occupant in an environment, comprising steps;
a wearable device configured to obtain biometric data and a comfort level of the occupant and measuring continuously environmental data in the environment as current conditions;
a processor configured to adapt continuously an estimate of a comfort index of the occupant based on the current conditions; and
a HVAC system that is controlled according to the estimate of the comfort index.

14. The system of claim 13, wherein the comfort level is self-reported by the occupant using the wearable device.
